(19) United States
(12) Patent Application Publication
(10) Pub. No.: US 2017/0047781 A1
(43) Pub. Date: Feb. 16, 2017

(54) METHOD AND APPARATUS FOR IN-BAND SIGNALING USING PARASITIC RESISTANCES

(71) Applicant: QUALCOMM Incorporated, San Diego, CA (US)

(72) Inventors: Wojciech Grzegorz Stanislawski, Valley Center, CA (US); William Henry Von Novak, III, San Diego, CA (US)

(21) Appl. No.: 15/060,459

(22) Filed: Mar. 3, 2016

Related U.S. Application Data
(60) Provisional application No. 62/204,249, filed on Aug. 12, 2015.

(51) Int. Cl. H02J 50/12; H02J 7/02

(52) U.S. Cl. CPC H02J 50/12; H02J 7/025

(57) ABSTRACT

An apparatus for wireless power transfer comprises a coupler having a first resistance and configured to generate a voltage under influence of a time-varying magnetic field generated by a wireless power transmitter. The apparatus comprises a rectifier circuit configured to rectify the voltage. The apparatus comprises a switching circuit coupled to an output of the rectifier circuit and having a first state and a second state. A first amount of power dissipated by at least the first resistance and the rectifier circuit in the first state and a second amount of power dissipated by at least the first resistance and the rectifier circuit in the second state. The apparatus comprises a controller configured to toggle the switching circuit between the first state and the second state. A difference between the second and first amounts of power is differentiable by the wireless power transmitter.

### CLAIM OF PRIORITY UNDER 35 U.S.C. §119

The present Application for Patent claims priority to Provisional Application No. 62/204,249 entitled “METHOD AND APPARATUS FOR IN-BAND SIGNALING USIGN PARASITIC RESISTANCES” filed Aug. 12, 2015, and assigned to the assignee hereof. Provisional Application No. 62/204,249 is hereby expressly incorporated by reference herein.

### FIELD

This application is generally related to wireless charging, and more specifically to methods and apparatuses for in-band reverse signaling using parasitic resistances.

### BACKGROUND

In wireless power applications, wireless power charging systems may provide the ability to charge and/or power electronic devices without physical, electrical connections, thus reducing the number of components required for operation of the electronic devices and simplifying the use of the electronic device. Such wireless power charging systems may comprise a transmitter coupler and other transmitting circuitry configured to generate a magnetic field that may induce a current in a receiver coupler that may be connected to the electronic device to be charged or powered wirelessly. Similarly, the electronic devices may comprise a receiver coupler and other receiving circuitry configured to generate a current when exposed to a magnetic field. In some implementations, wireless power transmitters and wireless power receivers are configured to communicate with one another to setup, regulate and sometimes drop charging sessions. Solutions for improving or enabling communication more efficiently or more cost effectively while accommodating various levels of power draw are desirable.

### SUMMARY

According to some implementations, an apparatus for wireless power transfer is provided. The apparatus comprises a coupler having a first resistance. The coupler is configured to generate a voltage under influence of a time-varying magnetic field generated by a wireless power transmitter. The apparatus comprises a rectifier circuit configured to rectify the voltage. The apparatus comprises a switching circuit coupled to an output of the rectifier circuit and having a first state and a second state, a first amount of power dissipated by at least the first resistance and the rectifier circuit in the first state and a second amount of power dissipated by at least the first resistance and the rectifier circuit in the second state. The apparatus comprises a controller configured to toggle the switching circuit between the first state and the second state. A difference between the second amount of power and the first amount of power is differentiable by the wireless power transmitter.

In some other implementations, a method for wireless power transfer is provided. The method comprises generating a voltage utilizing a coupler under influence of a time-varying magnetic field generated by a wireless power transmitter. The method further comprises rectifying the voltage utilizing a rectifier circuit. The method further comprises toggling a switching circuit coupled to an output of the rectifier circuit between a first state and a second state. A first amount of power is dissipated by at least a first resistance of the coupler and the rectifier circuit in the first state and a second amount of power is dissipated by at least the first resistance and the rectifier circuit in the second state. A difference between the second amount of power and the first amount of power is differentiable by the wireless power transmitter.

In yet other implementations, a non-transitory, computer-readable medium comprises code that, when executed, causes an apparatus for wireless power transfer to generate a voltage utilizing a coupler under influence of a time-varying magnetic field generated by a wireless power transmitter. The code, when executed, further causes the apparatus to rectify the voltage utilizing a rectifier circuit. The code, when executed, further causes the apparatus to toggle a switching circuit coupled to an output of the rectifier circuit between a first state and a second state. A first amount of power is dissipated by at least a first resistance of the coupler and the rectifier circuit in the first state and a second amount of power is dissipated by at least the first resistance and the rectifier circuit in the second state. A difference between the second amount of power and the first amount of power is differentiable by the wireless power transmitter.

In yet other implementations, an apparatus for testing an impedance range of a wireless power transmitter is provided. The apparatus comprises means for generating a voltage under influence of a time-varying magnetic field generated by a wireless power transmitter. The means for generating the voltage has a first resistance. The apparatus comprises means for rectifying the voltage. The apparatus comprises means for toggling between a first state and a second state. A first amount of power is dissipated by at least the first resistance and the means for rectifying the voltage in the first state and a second amount of power is dissipated by at least the first resistance and the means for rectifying the voltage in the second state. A difference between the second amount of power and the first amount of power is differentiable by the wireless power transmitter.

### BRIEF DESCRIPTION OF THE DRAWINGS

FIG. 1 is a functional block diagram of a wireless power transfer system, in accordance with some exemplary implementations.

FIG. 2 is a functional block diagram of a wireless power transfer system, in accordance with some other exemplary implementations.

FIG. 3 is a schematic diagram of a portion of transmit circuitry or receive circuitry of FIG. 2 including a transmit or receive coupler, in accordance with some exemplary implementations.

FIG. 4 shows a hybrid schematic/functional block diagram of an apparatus for wireless power transfer including a signaling resistor, in accordance with some implementations.

FIG. 5 shows a hybrid schematic/functional block diagram of another apparatus for wireless power transfer including a signaling resistor, in accordance with some implementations.

FIG. 6 shows a hybrid schematic/functional block diagram of an apparatus for wireless power transfer not including a signaling resistor, in accordance with some implementations.

FIG. 7 shows a hybrid schematic/functional block diagram of another apparatus for wireless power transfer not including a signaling resistor, in accordance with some implementations.

FIG. 8 is a flowchart depicting a method for wireless power transfer, in accordance with some implementations.

### DETAILED DESCRIPTION

In the following detailed description, reference is made to the accompanying drawings, which form a part of the present disclosure. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and form part of this disclosure.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured, or coupled by a “receive coupler” to achieve power transfer.

The terminology used herein is for the purpose of describing particular implementations only and is not intended to be limiting on the disclosure. It will be understood that if a specific number of a claim element is intended, such intent will be explicitly recited in the claim, and in the absence of such recitation, no such intent is present. For example, as used herein, the singular forms “a,” “an” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and “including,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

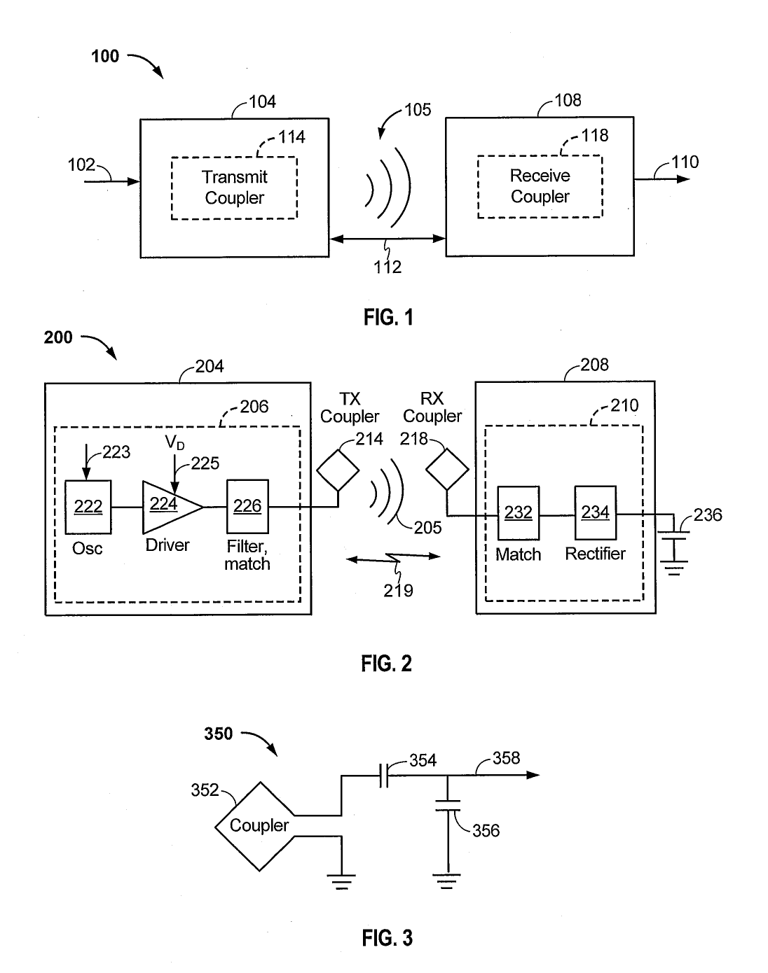

FIG. 1 is a functional block diagram of a wireless power transfer system 100, in accordance with some exemplary implementations. Input power 102 may be provided to a transmitter 104 from a power source (not shown) to generate a wireless (e.g., magnetic or electromagnetic) field 105 via a transmit coupler 114 for performing energy transfer. The receiver 108 including a receive coupler 118 may receive power when the receiver 108 is located in the wireless field 105 produced by the transmitter 104. The wireless field 105 corresponds to a region where energy output by the transmitter 104 may be captured by the receiver 108. A receiver 108 may couple to the wireless field 105 and generate output power 110 for storing or consumption by a device (not shown in this figure) coupled to the output power 110. Both the transmitter 104 and the receiver 108 are separated by a distance 112.

In one example implementation, power is transferred inductively via a time-varying magnetic field generated by the transmit coupler 114. The transmitter 104 and the receiver 108 may further be configured according to a mutual resonant relationship. When the resonant frequency of the receiver 108 and the resonant frequency of the transmitter 104 are substantially the same or very close, transmission losses between the transmitter 104 and the receiver 108 are minimal. However, even when resonance between the transmitter 104 and receiver 108 are not matched, energy may be transferred, although the efficiency may be reduced. For example, the efficiency may be less when resonance is not matched. Transfer of energy occurs by coupling energy from the wireless field 105 of the transmit coupler 114 to the receive coupler 118, residing in the vicinity of the wireless field 105, rather than propagating the energy from the transmit coupler 114 into free space. Resonant inductive coupling techniques may thus allow for improved efficiency and power transfer over various distances and with a variety of inductive coupler configurations.

In some implementations, the wireless field 105 corresponds to the “near-field” of the transmitter 104. The near-field may correspond to a region in which there are strong reactive fields resulting from the currents and charges in the transmit coupler 114 that minimally radiate power away from the transmit coupler 114. The near-field may correspond to a region that is within about one wavelength (or a fraction thereof) of the transmit coupler 114. Efficient energy transfer may occur by coupling a large portion of the energy in the wireless field 105 to the receive coupler 118 rather than propagating most of the energy in an electromagnetic wave to the far field. When positioned within the wireless field 105, a “coupling mode” may be developed between the transmit coupler 114 and the receive coupler 118.

FIG. 2 is a functional block diagram of a wireless power transfer system 200, in accordance with some other exemplary implementations. The system 200 may be a wireless power transfer system of similar operation and functionality as the system 100 of FIG. 1. However, the system 200 provides additional details regarding the components of the wireless power transfer system 200 as compared to FIG. 1. The system 200 includes a transmitter 204 and a receiver 208. The transmitter 204 includes transmit circuitry 206 that includes an oscillator 222, a driver circuit 224, and a filter and matching circuit 226. The oscillator 222 may be configured to generate a signal at a desired frequency that may be adjusted in response to a frequency control signal 223. The oscillator 222 provides the oscillator signal to the driver circuit 224. The driver circuit 224 may be configured to drive the transmit coupler 214 at a resonant frequency of the transmit coupler 214 based on an input voltage signal (V_{D}) 225.

The filter and matching circuit 226 filters out harmonics or other unwanted frequencies and matches the impedance of the transmit circuitry 206 to the transmit coupler 214. As a result of driving the transmit coupler 214, the transmit coupler 214 generates a wireless field 205 to wirelessly output power at a level sufficient for charging a battery 236.

The receiver 208 comprises receive circuitry 210 that includes a matching circuit 232 and a rectifier circuit 234. The matching circuit 232 may match the impedance of the receive circuitry 210 to the impedance of the receive coupler 218. The rectifier circuit 234 may generate a direct current (DC) power output from an alternate current (AC) power input to charge the battery 236. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205. In some implementations, the receiver 208 may be configured to determine whether an amount of power transmitted by the transmitter 204 and received by the receiver 208 is appropriate for charging the battery 236.

FIG. 3 is a schematic diagram of a portion of the transmit circuitry 206 or the receive circuitry 210 of FIG. 2, in accordance with some exemplary implementations. As illustrated in FIG. 3, transmit or receive circuitry 350 may include a coupler 352. The coupler 352 may also be referred to or be configured as a “conductor loop”, a coil, an inductor, an antenna, or a “magnetic” coupler. The term “coupler” generally refers to a component that may wirelessly output or receive energy for coupling to another “coupler.”

The resonant frequency of the loop or magnetic couplers is based on the inductance and capacitance of the loop or magnetic coupler. Inductance may be simply the inductance created by the coupler 352, whereas, capacitance may be added via a capacitor (or the self-capacitance of the coupler 352) to create a resonant structure at a desired resonant frequency. As a non-limiting example, a capacitor 354 and a capacitor 356 may be added to the transmit or receive circuitry 350 to create a resonant circuit that selects a signal 358 at a resonant frequency. For larger sized couplers using large diameter couplers exhibiting larger inductance, the value of capacitance needed to produce resonance may be lower. Furthermore, as the size of the coupler increases, coupling efficiency may increase. This is mainly true if the size of both transmit and receive couplers increase. For transmit couplers, the signal 358, with a frequency that substantially corresponds to the resonant frequency of the coupler 352, may be an input to the coupler 352.

As described above, in some implementations, wireless power transmitters and wireless power receivers are configured to communicate with one another to setup, regulate and sometimes drop charging sessions and the like. One method of such communication is called in-band signaling, where an amount of power drawn by the receiver 108, 208 and/or an impedance of the receiver 108, 208 is modulated at the receiver to encode a data stream that the transmitter 104, 204 can sense. However, such communications may require a minimum amount of change in power drawn by the receiver 108, 208 and/or in an impedance of the receiver 108, 208 to be able to be reliably and adequately detected by the transmitter 104, 204. Large chargeable devices may have no problem providing such minimum amounts of change. However, smaller chargeable devices may be configured to draw much smaller amounts of power even while charging. Such smaller amounts of power drawn during charging may make it difficult or impossible for these smaller chargeable devices to provide the requisite minimum amount of change in power drawn. Moreover, in some implementations, such smaller chargeable devices may be required to operate on a charging pad and receive charging power simultaneously with such large chargeable devices. Thus, simply designing a charger for smaller devices that relies upon smaller minimum amount of charging power drawn for reliably and accurately identifying such communications may not effectively solve the above-described problem where coexistence with larger chargeable devices is desired. For example, where a chargeable wearable device only draws 0.4 W of power while charging, a requisite minimum amount of change in power drawn of 0.5 W may be difficult to achieve since it would require the wireless power receiver 108, 208 to dissipate 0.9 W of power to achieve the 0.5 W change from the original value of 0.4 W, and this amount of power may not be achievable by a small receive coil designed to draw 0.4 W. Thus, methods and apparatuses for in-band reverse signaling using parasitic resistances are desirable.

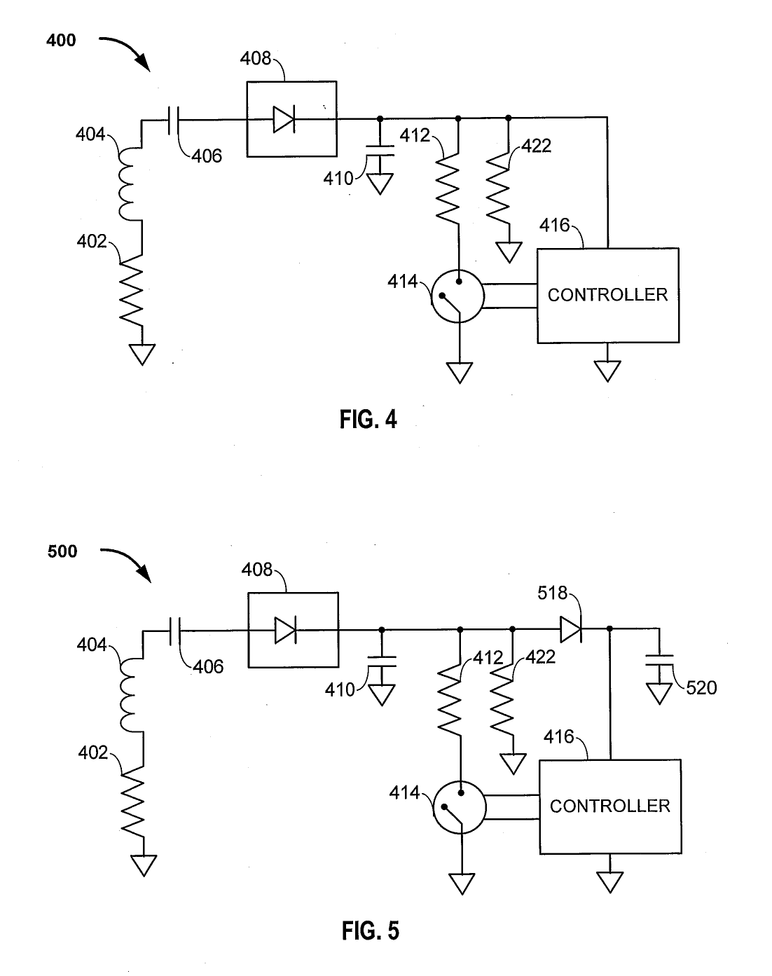

FIG. 4 shows a hybrid schematic/functional block diagram of an apparatus 400 for wireless power transfer including a signaling resistor 412, in accordance with some implementations. In some implementations, any of the apparatuses described in connection with FIGS. 4-7 may be integrated into a wearable device, such as a watch, smart device or Bluetooth device. The apparatus 400 includes a coil resistance 402, a coil 404 and a capacitor 406 connected in series with one another. The coil resistance 402 represents the parasitic resistance of the coil 404. Thus, in actuality the coil resistance 402 is an intrinsic property of the coil 404. The coil 404 and the capacitor 406, together, comprise a coupler or resonator configured to resonate at approximately a same frequency as a coupler or resonator of a wireless power transmitter (not shown in FIG. 4). In some implementations, the coil 404 and/or the capacitor 406 may also be referred to as or comprise at least a portion of “means for generating a voltage under influence of a time-varying magnetic field.”

The capacitor 406 is connected in series with an input of a rectifier circuit 408. In some implementations, the rectifier circuit 408 may comprise a diode. However, the present application is not so limited and the rectifier circuit 408 may also comprise a full bridge diode rectifier, a half bridge diode rectifier, a synchronous rectifier comprising one or more switches or any combination of any other known circuit that performs rectification may also be contemplated. The rectifier circuit may also be referred to as, or comprise at least a portion of “means for rectifying the voltage.” The output of the rectifier circuit 408 is connected to a first terminal of each of a smoothing capacitor 410, and a signaling resistor 412, and a load resistor 422. The second terminal of the smoothing capacitor 410 is connected to ground. A second terminal of the signaling resistor 412 is connected to a first terminal of a switching circuit 414, a second terminal of which is connected to ground. A second terminal of the load resistor 422 is connected to ground. In some implementations, the load resistor 422 may comprise a battery or any other circuitry of the apparatus 400 which may receive power provided by the resonator comprising the coil 404, the coil resistance 402 and the capacitor 406. In some implementations, the signaling resistor 412 may also be referred to as, or may comprise at least a portion of “means for dissipating power.” In some implementations, the signaling resistor 412 has a lower resistance than a load configured to receive power from the coupler. The output of the rectifier circuit 408 is also connected to a controller 416 in order to provide operating power to the controller 416. The controller 416 may further be connected to the switching circuit 414 and may be configured to control toggling of the switching circuit 414. In some implementations, the controller 416 may also be referred to as, or comprise at least a portion of “means for toggling between a first state and a second state.”

In operation, the wireless power transmitter (not shown in FIG. 4) generates a wireless magnetic field, which induces a voltage across the coil 404. When the controller 416 operates the switching circuit 414 to provide a closed circuit, the voltage induced in the coil 404 drives a current through the coil resistance 402, the coil 404, the capacitor 406, the rectifier circuit 408, the signaling resistor 412, the load resistor 422, and the switching circuit 414. The smoothing capacitor 410 alternates sinking and sourcing small amounts of current to smooth out both the voltage and the current provided at the output of the rectifier circuit 408. In certain implementations, the controller 416 may be powered by the output of the rectifier circuit 408 and so may draw small amounts of current from the output of the rectifier circuit 408 even when the switching circuit 414 is in an open circuit mode. When the controller 416 operates the switching circuit 414 to provide an open circuit, current will not flow as just described. The above-described two operating conditions in which current does or does not flow as previously described causes the wireless transmitter (not shown) to sense two different impedances and/or power dissipation values from the apparatus 400 when magnetically and inductively coupled with the apparatus 400. The wireless transmitter (not shown) may sense the modulation of these two different impedances and/or power dissipation values as a communication from the apparatus 400. Since substantially no current flows through the signaling resistor when the switching circuit 414 provides an open circuit, reduced power will be dissipated in the coil resistance 402 and the rectifier circuit 408. No power will be dissipated in the signaling resistor 412. However, since current flows when the switching circuit 414 provides a closed circuit, increased power will be dissipated in each of the coil resistance 402, the rectifier circuit 408, and the signaling resistor 412, where present. The modulation of the difference in power dissipated when the switching circuit 414 is in an open versus a closed state may be sensed as a communications signal by the wireless power transmitter (not shown) in an in-band, reverse signaling scheme. In some implementations, the difference in power dissipated when the switching circuit 414 is in an open versus a closed state may satisfy (e.g., exceed) a threshold for the wireless power transmitter to differentiate the first amount of power from the second amount of power, e.g., in some implementations between 0.5 Watts and 1.5 Watts.

With respect to DC power provided by the apparatus 400, the coil resistance 402, the coil 404, the capacitor 406, the rectifier circuit 408 and the smoothing capacitor 410 may be considered, collectively, as a DC voltage source. Thus, the voltage drop across the coil resistance 402 and across the rectifier circuit 408 may, collectively, be considered indicative of a voltage drop across a voltage source resistance or front end resistance of the apparatus 400. Where the apparatus 400 is a smaller chargeable device, this voltage source resistance may be large in comparison to an impedance presented by all components after the smoothing capacitor 410 (e.g., the voltage drop across the coil resistance 402 and across the rectifier circuit 408 may be too large to effectively satisfy the desired or required threshold of between 0.5 Watts and 1.5 Watts.)

Thus, rather than determining the threshold based only on power dissipated in the signaling resistor 412, the present application contemplates determining satisfaction of the threshold based on the sum of power dissipated in each of the coil resistance 402, the rectifier circuit 408 and, where present, the signaling resistor 412 (e.g., including power dissipated in only the front end and in implementations including the signaling resistor 412, also in the signaling resistor 412). At least one advantage to this determination is that the signaling resistor 412 may be smaller, having a smaller (or zero) resistance value, since at least a portion of the required threshold (e.g., 0.5-1.5 W) will be dissipated in the front end rather than all in the signaling resistor 412. As such, in accordance with some aspects, implementations described herein (with or without a signaling resistor 412 as described below), the coil resistance 402 and rectifier circuit 408 may dissipate, in a certain state, more power that an upper limit of power dissipated in a load (e.g., battery and other processors and circuitry of the device).

FIG. 5 shows a hybrid schematic/functional block diagram of another apparatus 500 for wireless power transfer, in accordance with some implementations. The apparatus 500 includes all components of the apparatus 400 (FIG. 4), however, further including a diode 518 disposed between the output of the rectifier circuit 408 and the controller 416. An anode of the diode 518 is connected to the output of the rectifier circuit 408 and a cathode of the diode 518 is connected to a capacitor 520, which when at least partially charged, provides sufficient power to operate the controller 416. The diode 518 prevents current stored in the capacitor 520 from flowing back through the signaling resistor 412. In this way, the diode 518 and the capacitor 520 ensure that sufficient power is available to operate the controller 416 when the switching circuit 414 provides an open circuit and insufficient voltage for powering the controller 416 appears at the output of the rectifier circuit 408. This may be desirable in some implementations since the switching circuit 414 providing a closed circuit (e.g., a short circuit) may cause the output voltage at the output of the rectifier circuit 408 to drop below a minimum required voltage for powering the controller 416. Thus, the capacitor 520 should be sized such that during the longest time period that the switching circuit 414 is closed, at the lowest operating voltage possible, there is still enough charge to power the controller 416 for that entire longest time period. In some implementations, the capacitor 520 may also be referred to as, or comprise at least a portion of “means for providing power to the means for toggling the switching circuit.”

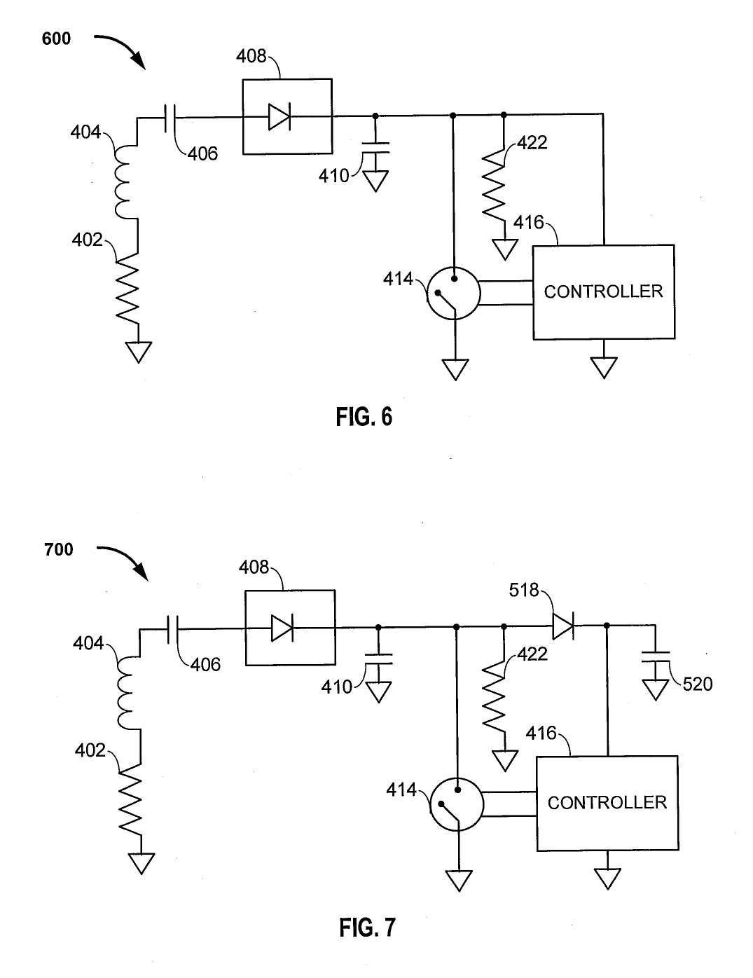

In some implementations, the signaling resistor 412 may not be present and the switching circuit 414 may be connected directly between the output of the rectifier circuit 408 and ground (see FIGS. 6 and 7). Thus, when the switching circuit 414 provides a short circuit between the output of the rectifier circuit 408 and ground, substantially all power dissipated during in-band reverse signaling will be dissipated in the components of the front end (e.g., in the coil resistance 402 and the rectifier circuit 408).

FIG. 6 shows a hybrid schematic/functional block diagram of an apparatus 600 for wireless power transfer not including a signaling resistor, in accordance with some implementations. The apparatus 600 includes all components of the apparatus 400 (FIG. 4), except the signaling resistor 412. When the switching circuit 414 is in a closed state (e.g., providing a path to ground) the voltage at the output of the rectifier circuit 408 may be substantially zero, which may be too low to power the controller 416. Thus, it may be desirable to additionally include the diode 518 and capacitor 520 as previously described in connection with FIG. 5 (see FIG. 7).

FIG. 7 shows a hybrid schematic/functional block diagram of another apparatus 700 for wireless power transfer not including a signaling resistor, in accordance with some implementations. The apparatus 600 includes all components of the apparatus 500 (FIG. 5), except the signaling resistor 412. When the switching circuit 414 is in a closed state (e.g., the switching circuit 414 providing a direct connection from the output of the rectifier circuit 408 to ground) the voltage at the output of the rectifier circuit 408 may be substantially zero, which may be too low to power the controller 416. Thus, the capacitor 520 may provide enough charge to power the controller 416 when the switching circuit 414 is in a closed state (e.g., providing a path to ground). The diode 518 ensures that none of the charge stored in the capacitor 520 flows to ground through the switching circuit 414 when the switching circuit 414 is in the closed state.

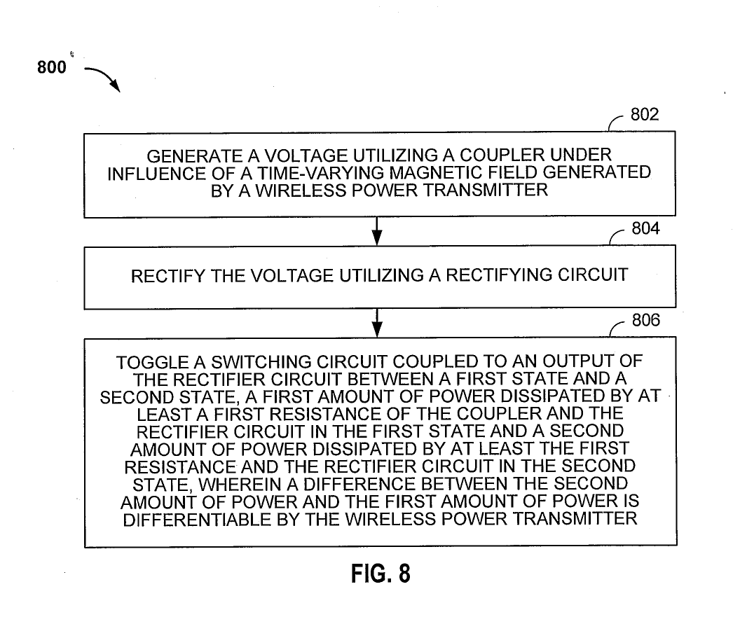

FIG. 8 is a flowchart 800 depicting a method for wireless power transfer, in accordance with some exemplary implementations. The flowchart 800 is described herein with reference to FIGS. 4-7. In some implementations, one or more of the blocks in flowchart 800 may be performed by a wireless power receiver, such as the apparatuses 400, 50, 600, 700 as shown in FIGS. 4-7, respectively. Although the flowchart 800 is described herein with reference to a particular order, in various implementations, blocks herein may be performed in a different order, or omitted, and additional blocks may be added.

Block 802 includes generating a voltage utilizing a coupler under influence of a time-varying magnetic field generated by a wireless power transmitter. For example, the coupler comprising the coil 404 and the capacitor 406 generates a voltage under influence of a time-varying magnetic field generated by a wireless power transmitter such as the transmitter 104, 204 of FIGS. 1 and 2, respectively.

Block 804 includes rectifying the voltage utilizing a rectifier circuit. For example, the rectifier circuit 408 may rectify the voltage generated by the coupler comprising the coil 404 and the capacitor 406.

Block 806 includes toggling a switching circuit coupled to an output of the rectifier circuit between a first state and a second state. For example, the controller 416 may be configured to toggle the switching circuit 414 between a first state (e.g., an open circuit state) and a second state (e.g., a closed circuit state). A first amount of power is dissipated by at least a first resistance of the coupler and the rectifier circuit in the first state and a second amount of power dissipated by at least the first resistance and the rectifier circuit in the second state. For example, a first amount of power is dissipated by at least the resistance 402 of the coupler (e.g., of the coil 404) and the rectifier circuit 408 in the first state and a second amount of power dissipated by at least the resistance 402 and the rectifier circuit 408 in the second state, as shown in FIGS. 4 and 5. In some implementations, the first amount of power is dissipated by at least the first resistance 402 and the rectifier circuit 408 in the first state, while the second amount of power is dissipated by at least the first resistance 402, the rectifier circuit 408 and the signaling resistor 412 disposed between an output of the rectifier circuit 408 and the switching circuit 414 in the second state. A difference between the second amount of power and the first amount of power is differentiable by the wireless power transmitter 104, 204 (e.g., satisfies a threshold for differentiating the first amount of power from the second amount of power). In some implementations, the threshold is greater than or equal to 0.5 watts and less than or equal to 1.5 watts, although any other range of power is also contemplated for the threshold. Thus, the difference between the second amount of power and the first amount of power satisfies a threshold for the wireless power transmitter 104, 204 to identify the difference as a communication. Thus, the controller 416 may be configured to toggle the switching circuit 414 between the first state and the second state according to a pattern corresponding to data for communication from the apparatus.

In some implementations, such a wireless power receiver may further include a diode 518 having an anode connected to an output of the rectifier circuit 408 and a cathode connected to the controller 416 and a first capacitor 520 having a first terminal connected to the cathode of the diode 518 and a second terminal connected to ground. As previously stated, the coupler comprises a coil 404 and a second capacitor 406 and the first resistance 402 comprises a parasitic resistance of the coil 404.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations.

The various illustrative blocks, modules, and circuits described in connection with the implementations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the implementations disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media. The processor and the storage medium may reside in an ASIC.

For purposes of summarizing the disclosure, certain aspects, advantages and novel features have been described herein. It is to be understood that not necessarily all such advantages may be achieved in accordance with any particular implementation. Thus, one or more implementations achieves or optimizes one advantage or group of advantages as taught herein without necessarily achieving other advantages as may be taught or suggested herein.

Various modifications of the above described implementations will be readily apparent, and the generic principles defined herein may be applied to other implementations without departing from the spirit or scope of the application. Thus, the present application is not intended to be limited to the implementations shown herein but is to be accorded the widest scope consistent with the principles and novel features disclosed herein.

What is claimed is:

1. An apparatus for wireless power transfer, comprising:
a coupler having a first resistance, the coupler configured to generate a voltage under influence of a time-varying magnetic field generated by a wireless power transmitter;
a rectifier circuit configured to rectify the voltage;
a switching circuit coupled to an output of the rectifier circuit and having a first state and a second state, a first amount of power dissipated by at least the first resistance and the rectifier circuit in the first state and a second amount of power dissipated by at least the first resistance and the rectifier circuit in the second state; and
a controller configured to toggle the switching circuit between the first state and the second state, wherein a difference between the second amount of power and the first amount of power is differentiable by the wireless power transmitter.

2. The apparatus of claim 1, further comprising a signaling resistor electrically connected between the output of the rectifier circuit and the switching circuit, wherein the first amount of power is dissipated by at least the first resistance and the rectifier circuit, while the second amount of power is dissipated by at least the first resistance, the rectifier circuit and the signaling resistor.

3. The apparatus of claim 2, wherein the signaling resistor has a lower resistance than a load configured to receive power from the coupler.

4. The apparatus of claim 1, wherein power dissipated in the second state is greater than an upper limit of power dissipated by a load electrically coupled to the output of the rectifier circuit.

5. The apparatus of claim 1, wherein the difference between the second amount of power and the first amount of power is greater than or equal to 0.5 watts.

6. The apparatus of claim 1, wherein the difference between the second amount of power and the first amount of power is less than or equal to 1.5 watts.

7. The apparatus of claim 1, wherein the switching circuit provides a direct connection from the output of the rectifier circuit to ground.

8. The apparatus of claim 1, further comprising:
a diode having an anode connected to the output of the rectifier circuit and a cathode connected to the controller; and
a first capacitor having a first terminal connected to the cathode of the diode and a second terminal connected to ground, the first capacitor configured to provide power to the controller at least when the switching circuit is in the second state.

9. The apparatus of claim 1, wherein the coupler comprises a coil and a capacitor, the first resistance comprising a parasitic resistance of the coil.

10. The apparatus of claim 1, wherein the difference between the second amount of power and the first amount of power satisfies a threshold for the wireless power transmitter to identify the difference as a communication from the apparatus.

11. The apparatus of claim 1, wherein the controller is configured to toggle the switching circuit between the first state and the second state according to a pattern corresponding to data for communication from the apparatus.

12. The apparatus of claim 1, wherein the apparatus is integrated into a wearable device.

13. A method for wireless power transfer, comprising:
generating a voltage utilizing a coupler under influence of a time-varying magnetic field generated by a wireless power transmitter,
rectifying the voltage utilizing a rectifier circuit, and
toggling a switching circuit coupled to an output of the rectifier circuit between a first state and a second state, a first amount of power dissipated by at least a first resistance of the coupler and the rectifier circuit in the first state and a second amount of power dissipated by at least the first resistance and the rectifier circuit in the second state,
wherein a difference between the second amount of power and the first amount of power is differentiable by the wireless power transmitter.

14. The method of claim 13, wherein the first amount of power is dissipated by at least the first resistance and the rectifier circuit, while the second amount of power is dissipated by at least the first resistance, the rectifier circuit and a signaling resistor connected between the output of the rectifier circuit and the switching circuit.

15. The method of claim 14, wherein the signaling resistor has a lower resistance than a load configured to receive power from the coupler.

16. The method of claim 13, wherein the difference between the second amount of power and the first amount of power is greater than or equal to 0.5 watts.

17. The method of claim 13, the method further comprising providing a direct connection from the output of the rectifier circuit to ground via the switching circuit.

18. The method of claim 13, further comprising:
providing power to a controller at least when the switching circuit is in the second state utilizing:
a diode having an anode connected to the output of the rectifier circuit and a cathode connected to the controller; and
a first capacitor having a first terminal connected to the cathode of the diode and a second terminal connected to ground.

19. The method of claim 13, wherein the coupler comprises a coil and a capacitor, the first resistance comprising a parasitic resistance of the coil.

20. The method of claim 13, wherein the difference between the second amount of power and the first amount of power satisfies a threshold for the wireless power transmitter to identify the difference as a communication.

21. The method of claim 13, wherein the switching circuit is toggled between the first state and the second state according to a pattern corresponding to data to be communicated.

22. The method of claim 13, further comprising providing power received by the coupler to a wearable device.

23. An apparatus for wireless power transfer, comprising:
means for generating a voltage under influence of a time-varying magnetic field generated by a wireless power transmitter, the means for generating the voltage having a first resistance;
means for rectifying the voltage; and
means for toggling between a first state and a second state, a first amount of power dissipated by at least the first resistance and the means for rectifying the voltage in the first state and a second amount of power dissipated by at least the first resistance and the means for rectifying the voltage in the second state,
wherein a difference between the second amount of power and the first amount of power is differentiable by the wireless power transmitter.

24. The apparatus of claim 23, further comprising means for dissipating power disposed between an output of the means for rectifying the voltage and the means for toggling, wherein the first amount of power is dissipated by at least the first resistance and the means for rectifying the voltage, while the second amount of power is dissipated by at least the first resistance, the means for rectifying the voltage and the means for dissipating power.

25. The apparatus of claim 23, wherein the difference between the second amount of power and the first amount of power is greater than or equal to 0.5 watts.

26. The apparatus of claim 23, wherein the means for toggling provides a direct connection from an output of the means for rectifying the voltage to ground.

27. The apparatus of claim 23, further comprising:
a diode having an anode connected to an output of the means for rectifying the voltage and a cathode connected to the means for toggling between the first state and the second state; and
means for providing power to the means for toggling at least when the means for toggling is in the second state, the means for providing power having a first terminal connected to the cathode of the diode and a second terminal connected to ground.

28. The apparatus of claim 23, wherein the means for generating the voltage comprises a coil and a capacitor, the first resistance comprising a parasitic resistance of the coil.

29. The apparatus of claim 23, wherein the difference between the second amount of power and the first amount of power satisfies a threshold for the wireless power transmitter to identify the difference as a communication from the apparatus.

30. The apparatus of claim 23, wherein the means for toggling between the first state and the second state is configured to toggle between the first state and the second state according to a pattern corresponding to data for communication from the apparatus.
